(19) United States
(12) Patent Application Publication
(10) Pub. No.: US 2008/0277522 A1
(43) Pub. Date: Nov. 13, 2008

(54) POLYMERIC FILM WINDING SYSTEMS AND METHODS UTILIZING INK SPACING

(75) Inventors: Michael D. Delmore, Grant, MN (US); Victoria L. Evan, St. Paul, MN (US); Burt R. King, Minong, WI (US); Thomas L. Wood, Hudson, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/746,662

(22) Filed: May 10, 2007

(51) Int. Cl. B65H 18/00; B41F 31/00; B41J 2/01

(52) U.S. Cl. 242/520; 101/483; 347/2

(57) ABSTRACT

A method and system of winding polymeric film includes printing an ink pattern onto a length of polymeric film (e.g., low modulus, optical grade film) prior to winding. The film and the ink pattern are simultaneously wound about a cylinder to form a wound roll, with ink pattern being interposed between successively wound layers of film. The ink pattern establishes a gap between the outermost and immediately underlying wound layers of film. The gap facilitates natural movement (e.g., relaxation) of the outermost wound layer relative to the immediately underlying wound layer, thereby compensating for any winding-related stress or tension.

### BACKGROUND

The present invention relates to systems and methods for winding polymeric films in forming a wound roll. More particularly, it relates to systems and methods for minimizing occurrences of winding-related defects when winding polymeric films, for example winding low modulus films such as optical grade, low modulus polypropylene film.

Polymeric films are conventionally manufactured in roll form. Regardless of exact composition of the film, large scale production generally entails forming a continuous length or web of the film, and then winding the so-formed web about a rotating cylinder (or about a core mounted to the cylinder). For example, accepted polymeric film formation techniques include extruding a molten or melted resin (otherwise consisting of desired materials) to form a cast sheet or web. The cast web is stretched (e.g., uniaxially or biaxially stretched), for example using a length orienter and/or tenter, to impart desired tensile properties to the film before being wound at a winding station. Wound film may be trimmed or slit into more than one width and wound into at least as many rolls. Optionally, wound film may be allowed to set or age, requiring the film to be unwound and then re-wound at optionally a second winding station. In those instances where the film is optionally aged, the initially formed film is wound into what is referred to as a mill roll; subsequently, an optional second slitting operation is performed to slit or cut the mill roll into smaller width film lengths, which are in turn wound into stock or slit rolls at a separate winding station.

When provided as part of a continuous in-line manufacturing system, standard film winding devices are readily able to meet desired production speeds. That is to say, the cylinder/core about which the film is wound can rotate at high speeds, resulting in a tightly wound roll for subsequent distribution and/or processing (e.g., slitting and rewinding of a mill roll to form two or more stock rolls). Unfortunately, however, the high winding speeds, along with various film properties, can impart defects into the wound layers of film during winding. For example, non-uniform tensions and/or pressures are oftentimes imparted to the film during winding (e.g., at the outermost wound layer) due to various factors such as tolerance deviations in the winding device (e.g., tolerance run-outs in the winding cylinder), film stability at the winding device, caliper control of the film, etc. The resulting unevenness between the two wound layers (e.g., the outermost wound layer and an immediately underlying wound layer) can produce a wound-in defect(s) that later “grows” as multiple successive windings layers of the film are wound on top of the defect(s). These winding-induced defects can include tin can-type defects (e.g., the film roll exhibits a series of raised annular bands so as to resemble the side of a tin can), slip knots and gauge band types of defects. In this regard, while efforts are made to precisely design and build the mechanical components of the winding device, for large film width winding applications (e.g., on the order of 2 meters or greater), unavoidable precision runouts inherently produce non-uniform tension during winding; in instances where the affected film layer is unable to readily move (or relax) relative to the immediately underlying layer (e.g., due to friction), one or more of the winding-induced defects mentioned above can occur. Winding defects are typically more frequently observed when the film is thin.

A number of techniques have been used to aid winding. For example, it is known that the addition of slip particles or additives can reduce winding defects. However, films intended for optical applications can require minimal haze, and haze may be increased with the use of slip particles or additives. Also, winding defects in such optical grade films may manifest as changes in other intended optical properties. One example might be the formation of hard bands that locally stretch the film or alter its thickness. Additionally, if the desired optical properties of the film include optical phase retardation, as in the case of compensation films, hard bands and other winding defects may reduce the manufacturing yield for the manufacturer and/or quality of the product for the customer.

Beyond implementation of strict process control parameters, a long-practiced technique for minimizing winding-induced defects is to impart a knurl adjacent the opposing edges of the film (in the machine direction) prior to winding. The knurls are physically created, and theoretically inhibit overt movement or “slipping” of wound layers relative to one another, as described, for example, in U.S. Pat. Nos. 3,502,765 and 4,021,179. In addition and/or alternatively, various components can be added to the film composition to promote desired winding properties, such as a slip additive and/or silica or other “grippy” material.

While the above techniques have been found to greatly reduce occurrence of winding-induced defects for many types of films, they represent added manufacturing costs and, for other film constructions, either do not provide satisfactory results or are simply unavailable. For example, films exhibiting a relatively low tensile modulus, as well as relatively thin films, may not be amenable to the creation and maintenance of physically-imparted knurls. Thus, for example, physically knurling thin, low modulus polypropylene films has been found to not eliminate winding-induced defects. Further, regardless of the film construction, knurling devices can accumulate contaminants (e.g., dirt) over time, with these contaminants being undesirably transferred to subsequently-processed film. In addition, end use requirements may prohibit incorporating a slip agent, silica, or other material typically found to enhance winding properties. For example, optical grade films (e.g., birefringement optical films such as simultaneously biaxially oriented polyolefin films useful for enhancing viewing characteristics of a display, such as liquid crystal display) must satisfy stringent optical clarity requirements that are otherwise negatively impacted by the materials mentioned above.

While it may be possible to design and construct the winding device components to more exacting tolerances in an effort to hopefully reduce or eliminate winding-induced defects, the resulting device is likely to be cost prohibitive and thus not commercially viable, especially at the increasingly larger mill roll widths desired by film line manufacturers. In light of this constraint, a more desirable solution would entail modifying existing in-line film manufacturing/winding systems. Unfortunately, no such solutions are currently available. In fact, while U.S. Pat. No. 4,942,000 has suggested creating a knurl pattern via ink printed onto the film using an inkjet printer, the '000 Patent is expressly limited to high modulus films and thus does not envision a solution to the low modulus film winding problems described above.

Conventional film line manufacturing equipment is susceptible to winding-induced defects, and accepted solutions to this problem are expensive and may not be viable for various film constructions. Therefore, needs exist for an improved film manufacturing and winding systems and methods.

### SUMMARY

The present application discloses, inter alia, a method of winding a low modulus polymeric film. The method includes providing a length of low modulus polymeric film. An ink pattern is printed onto a surface of the film. Following printing, the film is wound onto a roller. In this regard, the ink pattern establishes a gap between an outermost wound layer of film and an immediately underlying layer of film to facilitate desired movement (e.g., relaxation) of the outermost would layer relative to the immediately underlying wound layer. In some embodiments, the ink pattern is printed using a low surface energy ink. In other embodiments, the ink pattern is printed to define a repeating pattern in a length or machine direction of the film and is characterized by at least one line extending in a non-perpendicular fashion relative to an edge of the film.

These and other aspects of the present application will be apparent from the detailed description below. In no event, however, should the above summaries be construed as limitations on the claimed subject matter which subject matter is defined solely by the attached claims, as may be amended during prosecution.

### BRIEF DESCRIPTION OF THE DRAWINGS

The accompanying drawings are included to help describe the present invention. The elements of the drawings are not necessarily to scale relative to each other. Like reference numerals designate like parts.

FIG. 1 is a block diagram of a system for winding a polymeric film provided as part of a polymeric film production line;

FIG. 2 is a flow diagram illustrating another method of winding a polymeric film;

FIG. 3 is a schematic side view of a slitting system useful with the method of FIG. 2;

FIGS. 4A and 4B are simplified top views of a polymeric film including a printed ink pattern in accordance with the method of FIGS. 1 or 2;

FIG. 5 is a simplified, cross-sectional view of the polymeric film and ink pattern during a winding operation; and

FIG. 6 is a side view of a wound roll of polymeric film following processing in accordance with the method of FIGS. 1 or 2.

### DETAILED DESCRIPTION

In general terms, the present disclosure provides systems and methods employing ink patterns in connection with a polymeric film winding operation to reduce occurrences of winding-induced defects in the wound roll. In this regard, film winding can occur at various stages of manufacture, for example in connection with initial film formation in which an elongated web of film is produced and wound as a relatively large width mill roll, in connection with a slitting operation in which the mill roll is cut or slit and re-wound into two or more stock rolls of commercially-acceptable width, etc. Aspects of the present disclosure are useful with these and other polymeric film winding operations.

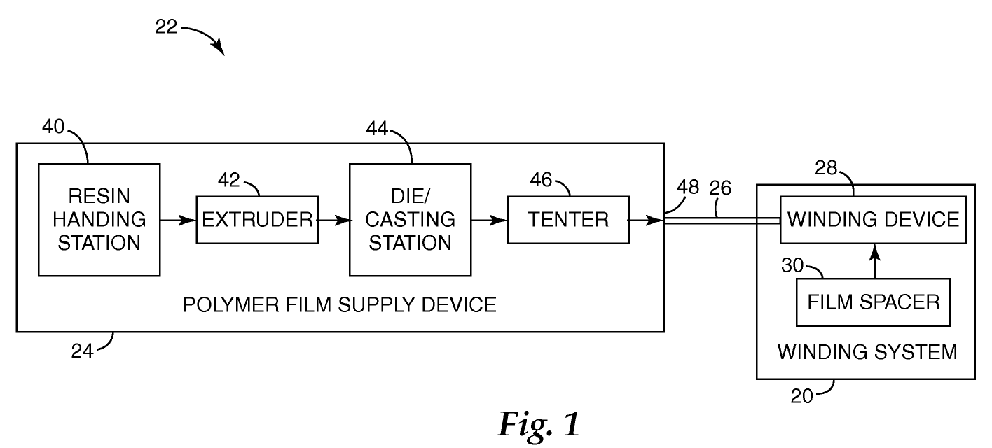

For example, one example of a winding system 20 for winding a polymeric film in accordance with aspects of the present invention is shown as part of a polymeric film manufacturing line 22 in FIG. 1. As described in greater detail below, the winding system 20 is adapted to wind polymeric film into roll form, with the polymeric film initially being provided or generated by a polymeric film supply device 24. In this regard, the film supply device 24 can assume a wide variety of forms, and generates or provides a web (e.g., a continuous web) of polymeric film 26 (illustrated generally in FIG. 1) to the winding system 20. The winding system 20 generally includes a winding device 28 and a film spacer 30. The winding device 28 is generally sized and adapted to effectuate winding of the film web 26 as a wound roll, with the film spacer 30 creating a slight gap between at least an outermost wound layer and an immediately underlying wound layer of film during winding, with this gap(s) facilitating movement (e.g., relaxation) of the outermost wound layer relative to the immediately underlying wound layer in a manner that reduces occurrences of winding-induced defects in the wound roll.

As indicated above, the manufacturing line 22, and in particular the polymeric film supply device 24, can be akin to conventional film line manufacturing devices typically used to manufacture polymeric film. For example, the polymeric film supply device 24 can include a resin handling/storage station 40, an extruder 42, a die/casting station 44, and a tenter 46. In general terms, desired resin constituents are maintained and/or combined within the resin handling station 40 and then supplied to the extruder 42. The extruder 42 melts the resin, and then extrudes the molten resin to the die/casting station 44. The die/casting station 44 effectuates desired hardening of the extruded cast melt to produce a cast sheet. The cast sheet is then stretched (e.g., biaxially stretched in the longitudinal and transverse directions) to form the polymeric film web 26. The stretched film web 26 can then be subjected to various other processes to effectuate desired film characteristics. Alternatively, the film web 226 can be produced by a cast film process followed by no stretching, sequential stretching, or either sequential or simultaneous biaxial stretching. Other film forming techniques can also be employed, such as, for example, a blown film process. Regardless, the resultant film web 26 is produced and supplied to the winding system 20 from an exit 48 (referenced generally) thereof. It will be understood, however, that this is but one acceptable system or technique for supplying the film web 26 to the winding system 20. In other embodiments, for example, the film web 26 can be created off-line relative to the winding system 20 (e.g., the film web 26 can be subjected to other processing following initial manufacture and then provided to the winding system 20).

As a point of reference, the winding system 20 described herein is useful with a wide variety of different polymeric film constructions. Thus, the winding system 20 can be employed to form wound rolls of film having different material constructions, thicknesses, physical properties (e.g., tensile modulus), optical properties, etc. In some embodiments, however, the winding system 20 is highly appropriate for winding or processing polymeric films that are otherwise likely to experience winding-induced defects using conventional winding devices (such as the winding device 28) and/or that are otherwise not amenable to the use of resin additives that have otherwise been found to improve winding properties. For example, the winding system 20 is highly useful with thin films (films having a thickness of less than about 50 microns, and including very thin films having a thickness of less than about 25 microns). Similarly, the winding system 20 is highly useful in winding films having a low tensile modulus (e.g., a modulus of less than about 2.0-2.75 GPa, such as polyolefin films including polypropylene). As previously described, films exhibiting one or both of these properties cannot be adequately knurled and/or continue to experience winding-induced defects following knurling. Similarly, films formulated for optical applications, such as optical displays or optical compensators for displays (e.g., liquid crystal displays) cannot include conventional modifiers such as slip agents or silica, normally understood to improve winding properties. The winding system 20 is highly appropriate for winding these optical grade films, where the phrase “optical grade film” is defined as a film that is free of surface defects and/or undesired optical artifacts that can cause a localized change in, for example, the birefringence, transparency or haze of the film. As a point of reference, acceptable polymeric optical grade films with which the winding system 20 is useful are described, for example, in U.S. Pat. No. 6,965,474 and U.S. Publication No. 2004/0156000, the teachings of which are incorporated herein by reference and that otherwise describe simultaneously biaxially stretched optical grade polymeric films. Thus, for example, in some embodiments, the winding system 20 along with the corresponding winding method described herein is used in connection with a highly thin (e.g., on the order of 15-20 microns), low modulus optical grade polypropylene film.

With the above background in mind, the film spacer 30 is provided in close proximity to, or as part of, the winding device 28. As a point of reference, the winding device 28 can be akin to a conventional film winder (e.g., film winders available from Bruckner, Inc., of Greenville, S.C.), and generally includes a cylinder about which the film web 26 is wound. The cylinder is driven to effectuate winding of the film 26, and thus has a longitudinal length corresponding with (i.e., slightly larger than) a cross-web width of the film 26. In some embodiments, for example, the film 26 can have a width of at least 4 meters, and in some embodiments a width greater than 6 meters, and yet other embodiments, a width that is greater than 10 meters; the cylinder thus has a corresponding longitudinal length. In addition, the winding device 28 can include additional components (not shown) and can be configured such that a core (not shown) is assembled over the cylinder and about which the film 26 is wound.

Regardless of an exact construction of the winding device 28, the film spacer 30 includes a print station at which an ink pattern is applied to the film 26 prior to winding about the cylinder of the winding device 28. Operation of the print station is described in greater detail below in connection with another embodiment in which the polymeric film 26 is wound (or re-wound) in connection with a slitting operation. In general terms, the print station includes one or more print heads that print an ink pattern(s) on to the film 26. The ink pattern(s), in turn, establish one or more small gaps between an outermost and immediately underlying wound layer of film during winding by the winding device 28. Thus promoting movement (e.g., relaxation) of the outermost wound layer relative to the immediately underlying wound layer, with this movement minimizing occurrences of winding-induced defects.

In one embodiment, the print station can include known means of applying an ink pattern to a film, including inkjet, die coating, gravure, other flexographic printing techniques and the like. These techniques can have direct contact between a device transporting the ink from a reservoir and the film (e.g. gravure coating), precise control of a coating gap between die and film (e.g. die coating), or precise control of ink flow from a print head (e.g. inkjet printing). The accuracy by which the application of ink is accomplished is related to the precision of the coating heads, roll run-out, and ability to control the flow of ink. It is preferred that the print station use a non-contact means of applying an ink pattern, such as inkjet printing.

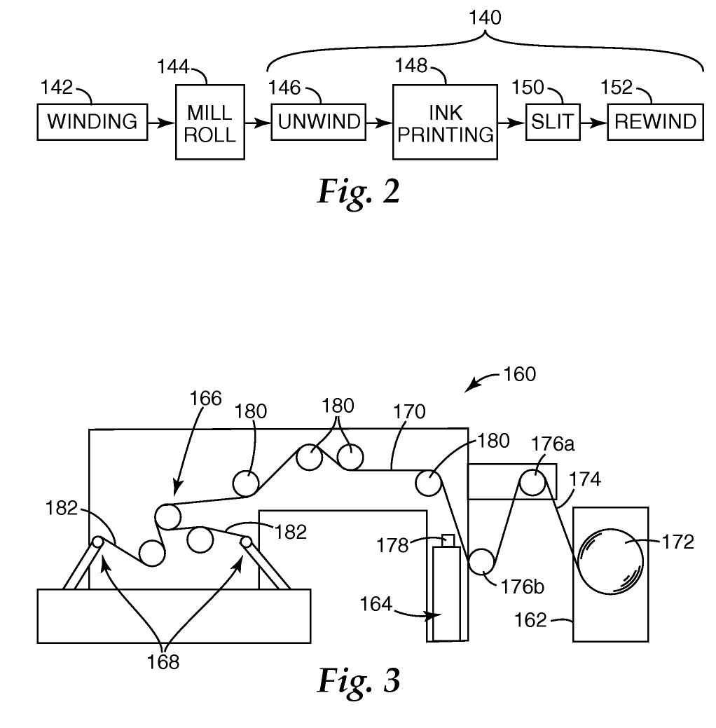

In other embodiments, aspects of the present disclosure relate to processing of a previously-wound roll (e.g., a mill roll) that may or may not have been processed to include the ink pattern(s) mentioned above. More particularly, the present disclosure can be applied in processing of a mill roll (i.e., has a relatively large width) that is cut (or slit) to produce two or more stock rolls of commercially-acceptable width. Slitting operations are well known, and generally entail unwinding of the mill roll, cutting or slitting the unwound film to two or more segments of desired width, and then rewinding the cut segments to form stock rolls. In connection with the rewinding portion of this process, the winding-induced defects described above can occur with conventional slitting/rewinding systems. With this in mind, FIG. 2 illustrates a further method in accordance with the present application whereby a slitting operation 140 is performed to include printing of one or more ink patterns on a surface of the film, with the ink patterns assisting in reducing occurrences of winding-induced defects.

In particular, following a winding operation at step 142, a mill roll is produced at 144. The mill roll can be the wound roll previously described with reference to FIG. 1, or can be a more conventional mill roll configuration. Regardless, the slitting operation 140 entails the mill roll being unwound at step 146, followed by printing of an ink pattern onto the unwound film at step 148 as described below. Subsequently, the printed film is slit at step 150, with the resultant slit film segments being re-wound as two or more stock rolls at step 152. It can be appreciated that the order of the ink printing step 148 and the slitting step 150, can be reversed if desired.

A slitting system 160 for performing the above operation is schematically illustrated in FIG. 3. In general terms, the slitting system 160 includes an unwind station 162, an ink printing station 164, a slitting station 166, and a rewind station 168. Apart from the print station 164, the slitting system 160 is akin to available slitting devices, with a travel path 170 being established from the unwind station 162 to the rewind station 168. More particularly, a mill roll 172 is loaded at the unwind station 162, and a length of polymeric film 174 extended (i.e., unwound) therefrom. The film 174 is directed from the unwind station 162 to the print station 164, for example via rollers 176a, 176b. The print station 164 is described in greater detail below, but generally includes one or more print heads 178 (schematically illustrated in FIG. 3) that print an ink pattern onto the film 174. From the print station 164, one or more rollers 180 (referenced generally) direct the film path 170 to the slit station 166 at which one or more cutting devices (not shown), such as razors, cut or slit the film 174. Finally, the cut segments 182 of the film 174 are directed to the rewind station 168 for subsequent rewinding as stock rolls.

The ink patterns created at the print station 164 serve to reduce occurrences of winding-induced defects within the stock rolls at the rewind station 168. That is to say, the ink patterns establish one or more small gaps between an outermost and immediately underlying wound layer of film during winding at the rewind station 168, thus promoting movement (e.g., relaxation) of the outermost wound layer relative to the immediately underlying wound layer. In this regard, in some embodiments, the print station 164 includes one or more inkjet printers that otherwise provide the printhead(s) 178. Inkjet printing generally relates to successively jetting small volumes, or droplets, of ink onto a surface. As is known, a fluid jet array is actuated (e.g., piezoelectric, thermal, etc.) to eject droplets of ink at a desired frequency. In one embodiment, the inkjet system is a two-head, continuous system in which the two printheads are simultaneously driven. For example, a two-head inkjet system available from KBA-Metronic AG of Veishochheim, Germany under the trade designation “AlphaJet C” is but one acceptable configuration. Alternatively, a wide variety of other inkjet printing systems or other printers capable of printing ink onto a film are also acceptable. Further, while the print station 164 is shown as being positioned between the unwind station 162 and the slit station 166, in other embodiments, the ink pattern can be applied following slitting (such that the print station 164 is located between the slit station 166 and the rewind station 168). Further, it will be understood that the print station 162 and related use thereof as described below is equally applicable as part of the film spacer 30 (FIG. 1).

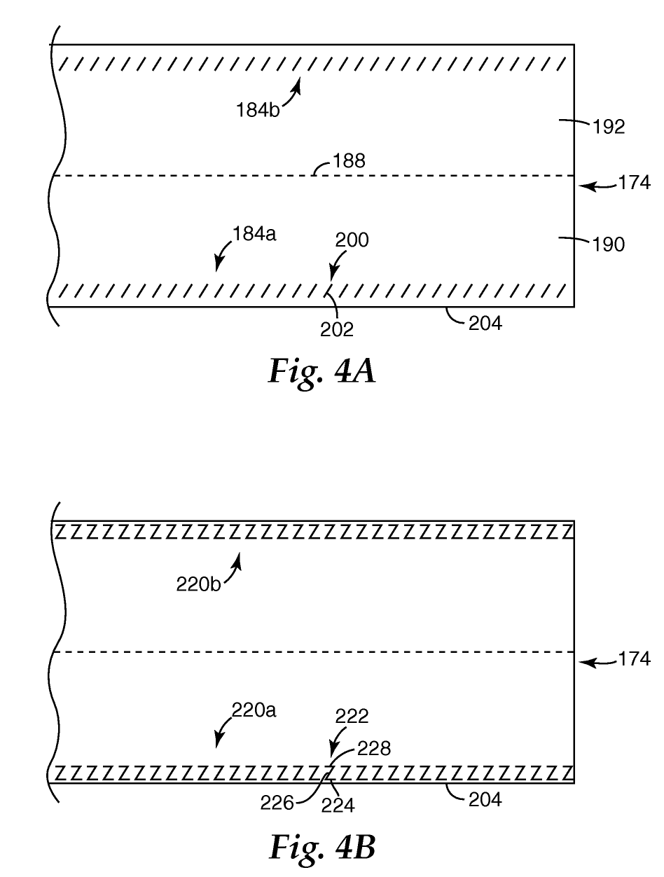

Regardless of the ink printing system or device employed, an ink pattern is printed onto the film 174, as shown, for example at 184a and 184b in FIG. 4A. As a point of reference, FIG. 4A illustrates the film 174 prior to slitting, it being understood that following slitting (e.g., along a theoretical slit line 188), the film 174 will effectively be divided into two segments 190, 192 that are subsequently wound as individual stock rolls. Thus, the first pattern 184a serves to reduce winding-induced defects during winding of the first segment 190, whereas the second pattern 18b improves winding performance of the second segment 192. Alternatively, two or more ink patterns can be associated with each individual film segment 190 or 192, and/or the film 174 can be slit into three or more segments (with each segment having one or more ink patterns associated therewith). Conversely, and as previously described, the ink patterns 184a, 184b can be applied after the slitting operation. Regardless, in some embodiments, the first and second ink patterns 184a, 184b are identical, such that the following description of the first ink pattern 184a is equally applicable to the second ink pattern 184b. Alternatively, the first and second ink patterns 184a, 184b (as well as additional ink patterns where provided) can differ.

The ink pattern 184a consists of a pattern portion 200 that is repeated along a longitudinal length of the film 174 (i.e., a repeating pattern in the machine direction of the film 174). The pattern portion 200 includes a plurality of individual ink droplets (not shown) that combine to effectively define a continuous line 202 that extends in an angular fashion relative to a corresponding edge 204 of the film 174. That is to say, the line 202 is oriented so as to not be perpendicular (or parallel) relative to the edge 204. Further, the line 202 has a length that is greater than its width, with the width being generally uniform. It has surprisingly been found that with this configuration and orientation, the ink pattern 184a does not create overt protrusions in the subsequently formed, wound roll as successively wound layers of the film 174 (and thus the pattern portions 200) are wound on top of one another (as might otherwise occur were the pattern portions 200 to include a dash extending perpendicular to the edge 204). In other words, the non-perpendicular orientation of the line 202 (relative to the edge 204) minimizes creation of instability in the wound roll.

A wide variety of other configurations of the pattern portion 200 are also envisioned. For example, FIG. 4B illustrates an alternative ink pattern 220a and 220b consisting of a repeating pattern portion 222. The pattern portion 222 has a “Z” shape and includes first, second, and third lines 224-228. The first and third lines 224, 228 are arranged generally parallel relative to the edge 204 of the film 174, and the second line 226 extends between and interconnects the first and third lines 224, 228, extending in a direction that is non-perpendicular relative to the edge 204. This pattern portion 222 configuration again avoids instability in the resultant wound roll while allowing an outermost wound layer to move or relax relative to the immediately underlying wound layer so as to minimize formation of stress-related defects.

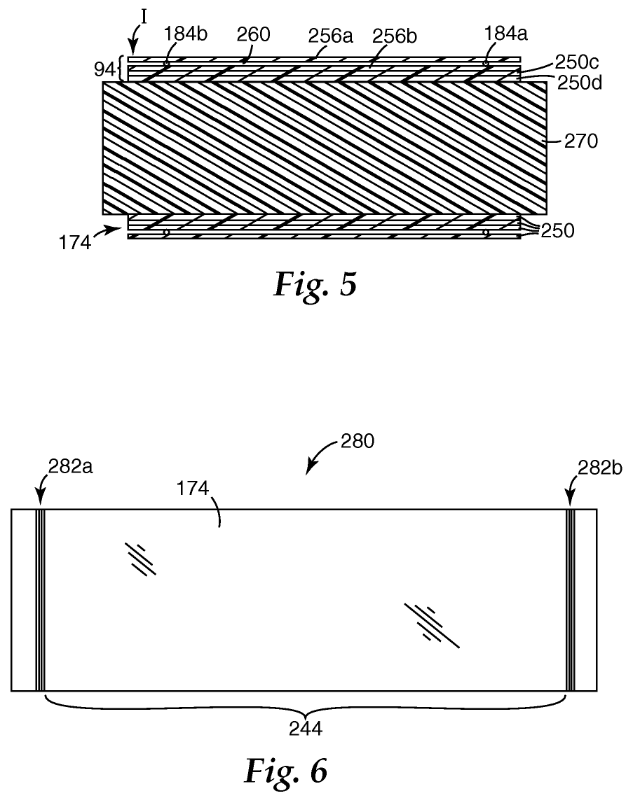

For example, with continuous winding of the film 174/ink pattern(s) 184a and 184b, the ink patterns 184a and 184b establish a slight gap between at least an outermost and immediately underlying wound layers of film. This relationship is further illustrated in FIG. 5 whereby the ink patterns 184a and 184b are positioned and continuously extend between adjacent ones of the wound layers of film 250 (referenced generally). Relative to an outermost and immediately underlying wound layers of film 250a, 250b, the defines one or more gaps 260 (referenced generally), with the gap(s) 260 being most prevalent at a wind interface I established relative to a winding cylinder 270 about which the film 174 is being wound (it being understood that the wind interface I is a theoretical point at which winding of the film 174 about the cylinder 270 initiates, and thus can be viewed as an “entrance” of the cylinder 270). In particular, as the film 174 is continually wound about the cylinder 270, inherent tension in the outermost wound layer 250a compresses the outermost wound layer 250a against the immediately underlying wound layer 250b. At least at the wind interface I, however, the ink patterns 184a and 184b effectively spaces the outermost and immediately underlying wound layers 250a, 250b (via the gap(s) 260). This, in turn, affords the outermost wound layer 250a a degree of freedom relative to the immediately underlying wound layer 250b such that the outermost wound layer 250a can relax (or otherwise move) relative to the immediately underlying wound layer 250b, thus releasing or overcoming any naturally induced stresses that might otherwise result from tolerance deviations inherent to the cylinder 270 (or other components of the winding device 28 (FIG. 1)). As a result, occurrences of winding-induced defects are greatly reduced and even eliminated. As shown in FIG. 5, the gap(s) 260 between adjacent wound layers of film 174 is reduced and eventually eliminated with multiple windings of the film 174 (e.g., relative to the wound layers of film 250c, 250d, the gap(s) 260 no longer exists due to radially compressive forces inherent to a wound roll).

Regardless of an exact configuration of the ink pattern 184a, 184b, 220a, 220b, the ink printing system and method described herein can be used with a variety of different films, and is of particular usefulness with thin, low modulus films, optical grade films, and/or polyolefins films such as polypropylene. It has surprisingly been found that with low modulus, polypropylene optical grade film having a thickness on the order of 10-25 microns, the ink patterns methods and systems described herein greatly reduce occurrences of winding-induced defects. With these and other applications, the ink used to form the ink pattern(s) is, in some embodiments, a solvent-based ink exhibiting strong adhesion a very low surface energy film (e.g., a film exhibiting a surface energy in the range of 28-32 dynes/cm², it being understood that the selected ink can also exhibit strong adhesion to films having surface energies greater than 32 dyns/cm² as well). For example, but in no way limiting, an ink employing a methyl-ethyl-ketone solvent, at about 85-95 percent by weight, alternatively about 90 percent by weight, is useful. This ink formulation results in a very low surface energy which in turn allows the ink to wet on the surface of an untreated polypropylene film prior to drying. It has surprisingly been found that these and other solvent-based inks exhibit sufficient adhesion to untreated polypropylene films to endure multiple and re-winds with “rubbing” off.

Further, the individual inkjet droplets otherwise forming the pattern segments have, in some embodiments, a height upon drying in the range of 0.5-5 microns, alternatively 2.7-3.5 microns. Alternatively, however, other ink formulations and/or droplet heights can be employed, for example ink materials exhibiting a relatively high coefficient of friction, such as Kraton rubber-based inks and the like. The high friction of these types of inks can stabilize the final roll of film by preventing the wound film layers from sliding relative to one another, similar to the effects provided by conventional film additives such as silica grit. Conversely, a low coefficient of friction ink can be beneficially employed. These types of inks allow wound layers of film to freely relax, a desired attribute where winding occurs after heat treatment of the film. Still further, a radiation curable ink, such as a UV curable ink, can be used, in which case a source of UV radiation to cure the ink will be placed adjacent the web path a at location after the ink jet head.

Regardless of the ink pattern/droplet configurations, the resultant roll (following processing by the rewind station 168 (FIG. 3)) is substantially free of winding-induced defects as shown in FIG. 6. More particularly, the resultant roll 280 (e.g., a stock roll) is characterized by banded regions 282 (otherwise imparted by the ink patterns 184a and 184b (FIG. 4A)) and at least one useful or un-banded region 284. During subsequent use, desired portions of the film 174 from the un-banded region(s) 244 can be used in a desired manner.

While the ink pattern-created film layer spacing has been described in the context of processing a mill roll into a stock roll following processing of the mill roll, in other embodiments the ink printing system and related method can be used apart from the strand spacing system and method. That is to say, the film spacer 30 of FIG. 1 can include the printing station 164 (FIG. 3).

The polymeric film winding and manufacturing methods and systems of the present application provide a marked improvement over conventional techniques in generating a wound roll of film with minimal or no winding-induced defects. Desired spacing between the outermost and immediately underlying wound layers of film are created by a separately provided ink pattern, with this approach representing a low cost alternative to knurling. This is of particular benefit for certain films (e.g., low modulus, thin, optical grade films such as optical grade polypropylene films) that are not otherwise amenable to knurling or implementation of resin additives that might otherwise improve winding properties.

The winding systems and methods described herein can be enhanced with additional components or steps. In some embodiments, a pack or contact roll(s) is employed in conjunction with the ink “banded” wound film (both low and high modulus films). As a point of reference, use of the pack or contact roll(s) is generally referred to as contact rolling, and allows the winding to occur with very low winding spindle tensions or torques because the contact roll(s) assist in forcing out excess air from between consecutively wound layers. This, in turn, can enhance layer-to-layer stability in the wound roll.

Although the present invention has been described with reference to preferred embodiments, workers skilled in the art will recognize that changes can be made in form and detail without departing from the spirit and scope of the present invention.

What is claimed is:

1. A method of winding a polymeric film, the method comprising:
providing a length of low modulus polymeric film, the film having a width defined between opposed edges;
printing at least one ink pattern onto a surface of the film; and
winding the film onto a roller following printing;
wherein the ink pattern establishes a gap between an outermost wound layer of film and an immediately underlying wound layer of film during winding of the film.

2. The method of claim 1, wherein printing the at least one ink pattern includes a non-contact printing means.

3. The method of claim 2, wherein the non-contact printing means includes ink jet printing.

4. The method of claim 1, wherein printing an ink pattern includes printing a low surface energy ink onto a surface of the film.

5. The method of claim 1, wherein printing an ink pattern includes printing a repeating pattern along a length direction of the film.

6. The method of claim 5, wherein the repeating pattern includes a line having a length greater than a width.

7. The method of claim 6, wherein a transverse distance of the line relative to one of the opposed edges of the film continuously varies in a length direction of the film.

8. The method of claim 6, wherein the line extends in a non-perpendicular fashion relative to one of the film edges in the length direction of the film.

9. The method of claim 6, wherein a portion of the repeating pattern includes a plurality of connected lines.

10. The method of claim 9, wherein the repeating pattern has a Z-shape.

11. The method of claim 6, wherein the line is defined by a plurality of connected ink droplets disposed on the film surface, the droplets each having a height, upon drying, of at least 2.5 microns.

12. The method of claim 11, wherein the height of the droplets, upon drying is not more than 4.0 microns.

13. The method of claim 1, wherein printing an ink pattern includes printing a solvent-based ink.

14. The method of claim 13, wherein the solvent-based ink is about 85 percent-95 percent solvent by weight.

15. The method of claim 13, wherein the solvent-based ink includes methyl-ethyl ketone as the solvent.

16. The method of claim 1, wherein providing a length of polymeric film includes providing a length of polyolefin film.

17. The method of claim 1, wherein providing a length of polymeric film includes providing a film having a tensile modulus of less than 2.75 GPa.

18. The method of claim 1, wherein providing a length of polymeric film includes providing a length of simultaneously biaxially oriented polypropylene film.

19. The method of claim 1, wherein providing a polymeric film includes providing an optical grade film.

20. The method of claim 1, wherein providing a length of polymeric film includes providing a film in a mill roll form, the method further comprising:
unwinding the film from the mill roll; and
slitting the unwound film;
wherein printing the ink pattern occurs after slitting.
